(19) United States
(12) Patent Application Publication
(10) Pub. No.: US 2025/0158300 A1
(43) Pub. Date: May 15, 2025

(54) Electrical Terminal Connectors for Battery Modules

(71) Applicant: SES (Shanghai) Co., Ltd., Shanghai (CN)

(72) Inventors: Chengcheng Zheng, Shanghai (CN); Jiwei Liang, Shanghai (CN)

(21) Appl. No.: 18/402,986

(22) Filed: Jan. 3, 2024

(30) Foreign Application Priority Data
Nov. 9, 2023 (CN) 2023114951694

(51) Int. Cl. H01R 11/09; H01M 50/50; H01R 4/18; H01R 4/34

(52) U.S. Cl. CPC H01R 11/09; H01M 50/50; H01R 4/183; H01R 4/34

(57) ABSTRACT

Electrical connectors that can be used with battery modules, such as battery modules containing one or more electrochemical cells, and that include features for precisely locating electrical conductors engaged with the electrical connectors and/or features for increasing robustness of the electrical connectors to overcurrent conditions. In some embodiments, each electrical connector includes a securing plate having multiple openings for securing the electrical connector to a positive or negative terminal of a battery module. In some embodiments, each electrical connector includes two or more tapering bridges extending between a securing plate and a pair of corresponding crimping clasps that receive corresponding respective current conductors or branches of a single current conductor during use. Electrical systems containing such electrical connectors are also disclosed.

### RELATED APPLICATION DATA

This application claims the benefit of priority of Chinese Invention patent application Ser. No. 20/231,14951694 filed on Nov. 9, 2023, and titled “Electrical Terminal Connectors for Battery Modules”, which is incorporated by reference herein in its entirety.

### FIELD OF THE DISCLOSURE

The present disclosure generally relates to the field of electrochemical batteries. In particular, the present disclosure is directed to electrical terminal connectors for battery modules.

### BACKGROUND

In some deployments of battery modules (e.g., battery modules containing electrochemical cells (e.g., lithium-ion cells or lithium-metal cells)), an electrical cable is connected to a terminal of a battery module using a flat annular electrical connector that is secured to the terminal using a single threaded fastener that passes through a central opening in the connector. As those skilled in the art will readily appreciate, when an installer tightens the threaded fastener, the location of the wire attached to the electrical connector can easily pivot in the direction of the tightening. In addition, such conventional electrical connectors are prone to being installed upside down, and they often do not have enough overcurrent capability to withstand high electrical currents required in high-current-draw applications for battery modules, for example, in electric vehicles (EVs) of any type, such as road-going EVs and airborne EVs.

### SUMMARY OF THE DISCLOSURE

In one implementation, the present disclosure is directed to an electrical connector for engaging a battery terminal. The electrical connector includes a securing plate for securing the electrical connector to the battery terminal, the securing plate having: first and second faces spaced apart from one another so as to provide a thickness; first and second ends located at opposite ends of the securing plate; first and second lateral sides spaced apart from one another on opposite sides of the longitudinal axis and extending between the first and second ends; and a plurality of openings spaced from one another between the first and second ends and each opening extending from the first face to the second face, wherein the plurality of openings are provided to facilitate connecting the electrical connector to the battery terminal; first and second crimping clasps located on one of the first and second lateral sides of the securing plate and spaced apart from one another; a first tapered bridge fixedly securing the first crimping clasp to the securing plate; and a second tapered bridge fixedly securing the second crimping clasp to the securing plate; wherein: each of the first and second tapered bridges tapers in width from the securing plate to the respective first and second crimping clasps; and each of the securing plate, the first and second crimping clasps, and the first and second tapered bridges is made of an electrically conductive material.

In another implementation, the present disclosure is directed to an electrical system, which includes a battery module that includes a battery terminal for electrically connecting the battery module to an external device; and an electrical connector coupled to the battery terminal of the battery module, the electrical connector including: a securing plate for securing the electrical connector to the battery terminal, the securing plate having: first and second faces spaced apart from one another so as to provide a thickness; first and second ends located at opposite ends of the securing plate; first and second lateral sides spaced apart from one another on opposite sides of the longitudinal axis and extending between the first and second ends; and a plurality of openings spaced from one another between the first and second ends and each opening extending from the first face to the second face, wherein the plurality of openings are provided to facilitate connecting the electrical connector to the battery terminal; first and second crimping clasps located on one of the first and second lateral sides of the securing plate and spaced apart from one another; a first tapered bridge fixedly securing the first crimping clasp to the securing plate; and a second tapered bridge fixedly securing the second crimping clasp to the securing plate; wherein: each of the first and second tapered bridges tapers in width from the securing plate to the respective first and second crimping clasps; and each of the securing plate, the first and second crimping clasps, and the first and second tapered bridges is made of an electrically conductive material.

### BRIEF DESCRIPTION OF THE DRAWINGS

For the purpose of illustrating the disclosure, the drawings show aspects of one or more embodiments of the disclosure. However, it should be understood that the present disclosure is not limited to the precise arrangements and instrumentalities shown in the drawings, wherein:

FIG. 1 is a partial side view/partial diagrammatic view of an electrical system that includes a battery module and a pair of electrical connectors coupled to electrical terminals of the battery module;

FIG. 2A is a perspective view of an electrical connector of the present disclosure that can be used for each of the electrical connectors of FIG. 1;

FIG. 2B is a plan view of the electrical connector of FIG. 2A;

FIG. 2C is a front view of the electrical connector of FIG. 2A;

FIG. 2D is a side view of the electrical connector of FIG. 2A;

FIG. 3A is a perspective view of the electrical connector of FIGS. 2A-2D secured to a battery module; and

FIG. 3B is a plan view of the electrical connector of FIG. 3A showing example distal ends of the electrical conductors crimped to the electrical connector.

### DETAILED DESCRIPTION

In some aspects, the present disclosure is directed to electrical connectors that provide not only locational precision and stability for electrical conductors (e.g., wires, cables, etc.) that are engaged with the electrical conductors, but also provide robust connections for high-current applications, such as EVs. In an example, a high-current application is one for which the rated current is 100A, the actual current is in a range of 100A to 150A, with a 150A current being sustained for at least 60 seconds. In some aspects, the present disclosure is directed to electrical systems that include one or more battery modules and electrical connectors made in accordance with the present disclosure securing electrical conductors to at least one of the battery modules. These and other aspects are described in detail below and/or illustrated in the appended drawings.

It is noted that the terms “first”, “second”, “third”, etc., when used herein to designate an element, feature, structure, component, etc., are used merely to designate differing ones of such elements, features, structures, components, etc., and not to convey any particular order, importance, arrangement, etc. It is also noted that, as used herein, the terms “top”, “side”, or “front”, and any like term indicating a view within a figure of the appended drawings is arbitrary, as the subject matter of such figure, when put into practice, can have any desired orientation. Similarly, the terms “above” and “below” as used herein apply only to the relevant view within a particular figure and not to any absolute frame of reference.

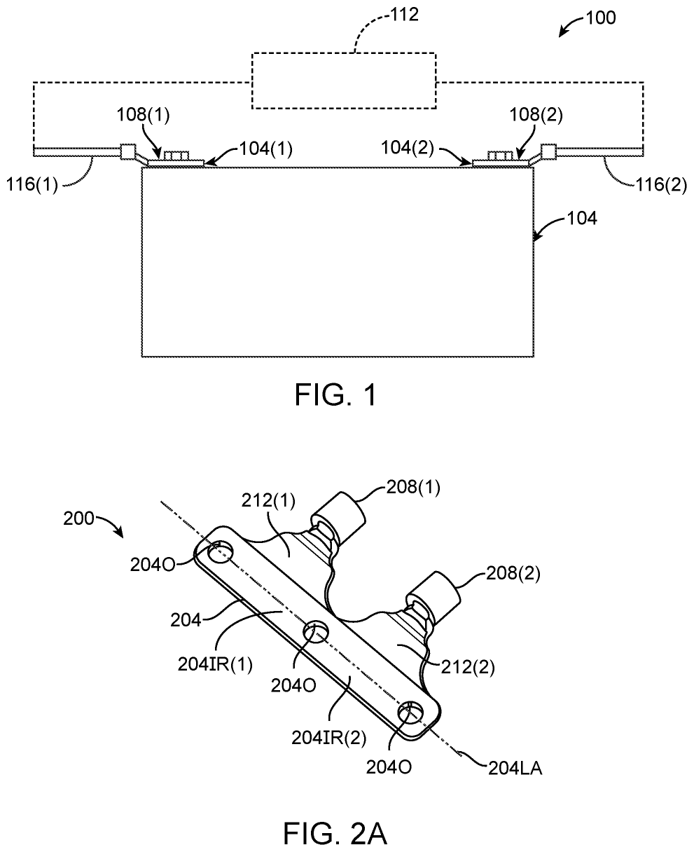

Turning now to the appended drawings, FIG. 1 illustrates an example electrical system 100 made in accordance with the present disclosure. In this example, the electrical system 100 includes a battery module 104, first and second electrical connectors 108(1) and 108(2) of the present disclosure coupled to output terminals 104(1) and 104(2) (of opposite polarities) of the battery module, respectively, and one or more external devices 112 to which the battery module is electrically connected via one or both of the first and second electrical connectors. For context, the battery module 104 can be any type of battery module, such as a battery module containing one or more electrochemical cells of any appropriate chemistry, such as, for example, lithium-ion chemistry, lithium-metal chemistry, sodium-based chemistry, or sulfur-based chemistry, among many others. The battery module 104 may alternatively be a battery pack that comprises multiple battery modules, such as multiple multiple-cell battery modules.

The external device(s) 112 can be any one or more devices that need to be connected to the battery module 104 to provide a functioning system. In some cases, both output terminals 104(1) and 104(2) will be connected to a single external device 112, such as a device that draws power directly from the battery module 104 or another battery module that is electrically connected in series with the battery module 104. Examples of power-drawing external devices include, but are not limited to, a motor controller and a power distribution box, among many others. In some embodiments, only one of the output terminals 104(1) and 104(2) will be connected to a corresponding external device 112, such as, for example, in the case of the external device being another battery module in electrical series with the battery module 104. Those skilled in the art will readily appreciate the many types of devices that the one or more external devices 112 can be. As discussed below in more detail, each of the first and second electrical connectors 108(1) and 108(2) crimpingly receives one or more electrical conductors, here, first and second electrical conductors 116(1) and 116(2), or two or more branches (not shown) of a single one of the first and second electrical conductors.

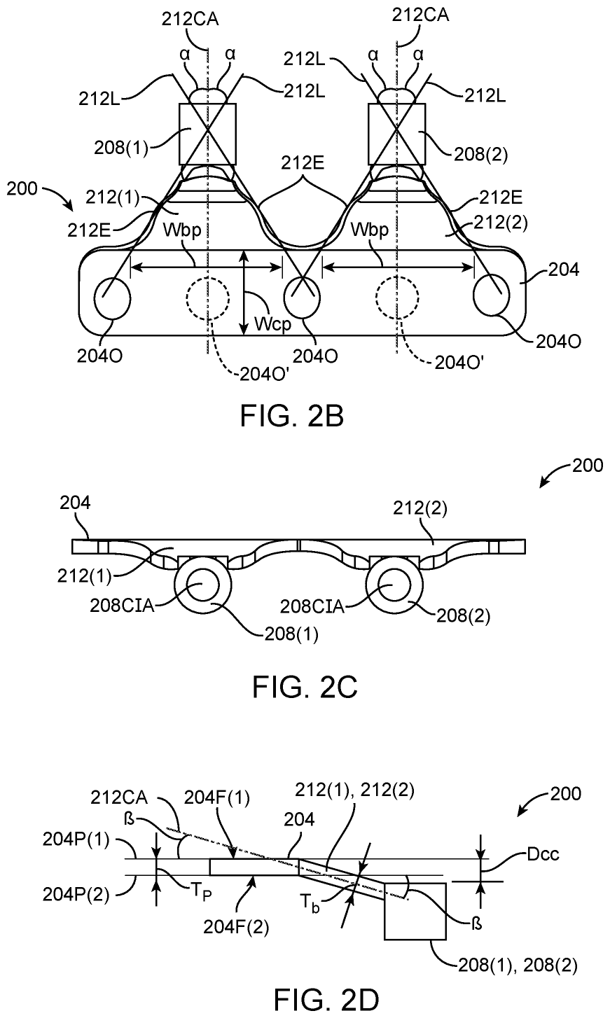

FIGS. 2A through 2D illustrate an example electrical connector 200 of the present disclosure that can be used, for example, for either or both of the first and second electrical connectors 108(1) and 108(2) of FIG. 1. As seen in each of these figures, the electrical connector 200 includes three primary components, namely, a securing plate 204, at least one crimping clasp, here, first and second crimping clasps 208(1) and 208(2), and at least one tapered bridge, here, first and second tapered bridges 212(1) and 212(2), each extending from the securing plate to the corresponding one of the tapered bridge(s). The rest of this disclosure addresses embodiments of an electrical connector having two crimping clasps and two bridges. However, those skilled in the art will readily appreciate that in other embodiments an electrical connector of the present disclosure may have a single crimping clasp and a single corresponding tapered bridge or may have three or more crimping clasps and three or more corresponding tapered bridges.

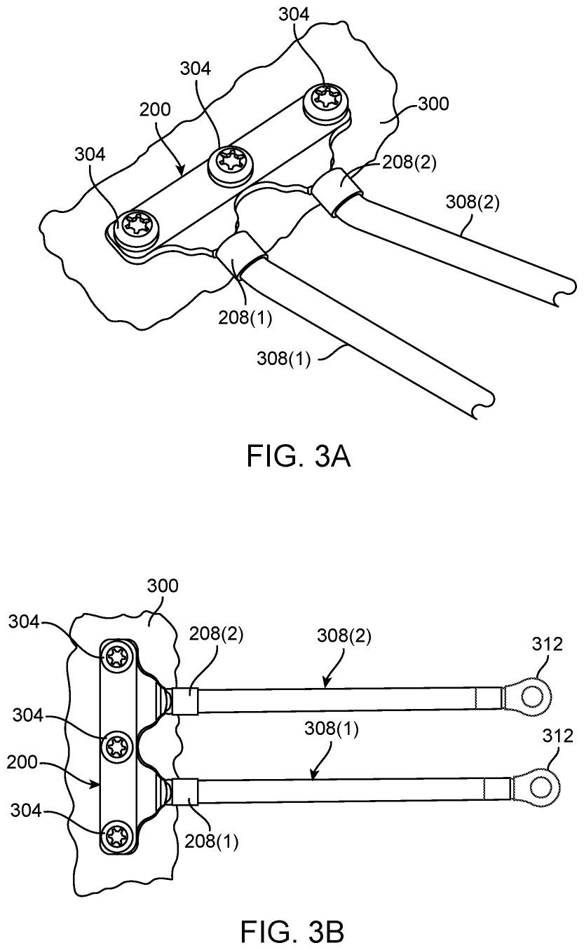

The securing plate 204 is designed and configured to engage a battery module (not shown, but see battery module 104 of FIG. 1) and to fixedly couple the electrical connector 200 to the battery module. As best seen in FIG. 2A, the securing plate 204 has a plurality of openings 2040, here three openings, for securing the electrical connector 200 to the battery module. Each of the openings is designed to receive either a headed threaded fastener (not shown, but see threaded fasteners 304 of FIGS. 3A and 3B), such as a screw, bolt, or similar fastener, or a threaded post (not shown) that is part of the output terminal (not shown, but see first and second output terminals 104(1) and 104(2) of FIG. 1). In the case of threaded posts, one or more threaded nuts or similar hardware can be used to threadingly engage each of the threaded posts to complete the secure connection.

In this example, the three openings 2040 are spaced evenly along the longitudinal axis 204LA of the securing plate 204, so as to define first and second inter-opening regions 204IR(1) and 204IR(2). In this embodiment, the first and second tapered bridges 212(1) and 212(2) are aligned with, respectively, the first and second inter-opening regions 204IR(1) and 204IR(2). In other embodiments, this alignment need not be used, nor do three openings 2040 need to be provided. For example, other embodiments may include two openings or four or more openings. As an example with two openings in the context of the electrical connector of FIG. 2B, the three openings 2040 may be replaced by two openings 2040′.

Still referring to FIG. 2B, each of the tapered bridges 212(1) and 212(2) has a central axis 212CA and pair of lateral edges 212E, nominally indicated by lines 212L, that each form a nominal non-zero taper angle, a, relative to the corresponding central axis 212CA. In an example, the taper angle α is 30 degrees. In other embodiments, the taper angle α is the same value. In this example, the lines 212L nominally denoting the nominal lateral edges 212E of the tapered bridges 212(1) and 212(2) each pass through a corresponding one of the openings 2040, and the width, Wbp, at the securing plate 204 is generally equal to twice the width, Wcp, of the region 204 between the openings. In this manner, the electrical current flowing from the electrical terminal (not shown) can effectively be collected from, or dispersed to (depending on the direction of current flow), the securing plate 204 by each of the tapered bridges 212(1) and 212(2) and then concentrated, or dispersed, by the tapering. In this example, the lateral edges 212E of each tapered bridge 212(1) and 212(2) is shaped to have a gently curved profile to divert the current while avoiding heat buildup from over-concentration of the current.

As FIG. 2D shows, in this example each of the tapered bridges 212(1) and 212(2) (FIGS. 2B and 2C) of the electrical connector 200 extends away from the securing plate 204 at a standoff angle, B, formed between each central axis 212CA of the tapered bridges and each of a pair of first and second planes 204P (1) and 204P (2) containing, respectively, corresponding faces 204F (1) and 204F (2) of the securing plate. In this manner, the portion of each crimping clasp 208(1) and 208(2) closest to the first plane 204P (1) is spaced at a distance, Dcc, from the first plane of the first face 204F (1), which in some embodiments is the face of the securing plate that confronts the corresponding battery module (not shown, but see battery module 104 of FIG. 1). The standoff angle is between 5 degrees and 30 degrees, which is intended to allow crimp fasteners 208(1) and 208(2) to be crimped to the wires with the edges of the insulated outer diameter of the wires flush with the plane of 204F (1) for ease of installation inside the device. Tapered bridges 212(1) and 212(2) are 6 mm at their narrowest point, and the thickness of the entire terminal is 1.5 mm, i.e., the smallest cross sectional area for overcurrent is 9 square millimeters, and the rated current of both tapered bridges 212(1) and 212(2) is 50A.

In the example shown, the securing plate 204 is made of a highly electrically conductive material, such as copper, aluminum, or a suitable alloy, among others, and, as seen in FIG. 2D, has a uniform thickness, Tp. In this example, the tapered bridges 212(1) and 212(2) each have a uniform thickness, Tb, and are made of a highly electrically conductive material, such as any of the materials just mentioned for the securing plate. In some embodiments, the securing plate 204 and the tapered bridges 212(1) and 212(2) can be formed from a single plate of conductive material, for example, by cold stamping. In other embodiments, the bridges 212(1) and 212(2) may be formed separately from the securing plate 204 and attached thereto, such as by welding or brazing, among other techniques. The crimping clasps 208(1) and 208(2) are likewise made of a suitable highly electrically conductive material, such as any of the materials noted above relative to the securing plate 204. In some embodiments, the crimping clasps 208(1) and 208(2) may be formed separately from the tapered bridges 212(1) and 212(2) and secured thereto by suitable means, such as welding or brazing, among others. In some embodiments, the crimping clasps 208(1) and 208(2) may be formed integrally with the tapered bridges 212(1) and 212(2), such as by cold-forming or other suitable method. In some embodiments, the entire electrical connector 200 can be formed from a single plate of material using one or more suitable techniques, such as one or more cold-forming techniques. In some embodiments, some or all of the electrical connector may be made using an additive-manufacturing process, such as 3D printing or casting, among others.

In some embodiments, each crimping clasp 208(1) and 208(2) may be of the hollow-cylinder type as shown in the figures so as to have an annular cross-sectional shape in a direction transverse to the conductor-insertion axis 208CIA (FIG. 2C). However, in other embodiments, each crimping clasp 208(1) and 208(2) may have another transverse cross-sectional shape, such as a U-shape or a C-shape, among others.

FIG. 3A shows the electrical connector 200 of FIGS. 2A through 2D secured to a battery module 300 via three threaded fasteners 304, which in this example, are hex-headed screws. FIG. 3A also shows a pair of electrical conductors 308(1) and 308(2), for example, wires or cables, crimpedly engaged with corresponding ones of the crimping clasps 208(1) and 208(2) of the electrical connector 200. Although not shown, the ends of the electrical conductors 308(1) and 308(2) opposite the electrical connector 200 may be connected to another battery module or to another device, such as any of the other devices mentioned above in connection with device(s) 112 of FIG. 1. FIG. 3B shows all of the elements of FIG. 3A but shows each of the electrical conductors 308(1) and 308(2) terminating in a conventional electrical connector 312.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present disclosure. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this disclosure. The appended claims are incorporated into this Detailed Description as if originally presented herein.

Exemplary embodiments have been disclosed above and illustrated in the accompanying drawings. It will be understood by those skilled in the art that various changes, omissions and additions may be made to that which is specifically disclosed herein without departing from the spirit and scope of the present disclosure.

What is claimed is:

1. An electrical connector for engaging a battery terminal, the electrical connector comprising:
a securing plate for securing the electrical connector to the battery terminal, the securing plate having:
first and second faces spaced apart from one another so as to provide a thickness;
first and second ends located at opposite ends of the securing plate;
first and second lateral sides spaced apart from one another on opposite sides of the longitudinal axis and extending between the first and second ends; and
a plurality of openings spaced from one another between the first and second ends and each opening extending from the first face to the second face, wherein the plurality of openings are provided to facilitate connecting the electrical connector to the battery terminal;
first and second crimping clasps located on one of the first and second lateral sides of the securing plate and spaced apart from one another;
a first tapered bridge fixedly securing the first crimping clasp to the securing plate; and
a second tapered bridge fixedly securing the second crimping clasp to the securing plate;
wherein:
each of the first and second tapered bridges tapers in width from the securing plate to the respective first and second crimping clasps; and
each of the securing plate, the first and second crimping clasps, and the first and second tapered bridges is made of an electrically conductive material.

2. The electrical connector of claim 1, wherein each of the first and second crimping clasps is an O-type crimping clasp.

3. The electrical connector of claim 1, wherein the first and second faces of the securing plate lie in corresponding respective first and second planes, and each of the first and second crimping clasps is spaced from both of the first and second planes.

4. The electrical connector of claim 3, wherein the first and second crimping clasps have corresponding respective first and second conductor-insertion axes lying in a third plane that is parallel to each of the first and second plane.

5. The electrical connector of claim 4, wherein the first and second conductor-insertion axes are parallel to one another.

6. The electrical connector of claim 3, wherein each of the first and second tapered bridges extends away from the securing plate at a standoff angle greater than zero degrees relative to each of the first and second planes.

7. The electrical connector of claim 6, wherein the standoff angle is between 5 degrees and 30 degrees.

8. The electrical connector of claim 1, wherein each of the first and second tapered bridges has first and second lateral sides extending from the securing plate to the corresponding first or second crimping clasp, and each of the first and second lateral sides has a taper angle in a range of 5 degrees to 30 degrees.

9. The electrical connector of claim 8, wherein the securing plate has three openings evenly spaced from one another to define first and second inter-opening regions of the securing plate, and each of the first and second tapered bridges is centered relative to a corresponding one of the first and second inter-opening regions.

10. An electrical system, comprising:
a battery module that includes a battery terminal for electrically connecting the battery module to an external device; and
an electrical connector coupled to the battery terminal of the battery module, the electrical connector including:
a securing plate for securing the electrical connector to the battery terminal, the securing plate having:
first and second faces spaced apart from one another so as to provide a thickness;
first and second ends located at opposite ends of the securing plate;
first and second lateral sides spaced apart from one another on opposite sides of the longitudinal axis and extending between the first and second ends; and
a plurality of openings spaced from one another between the first and second ends and each opening extending from the first face to the second face, wherein the plurality of openings are provided to facilitate connecting the electrical connector to the battery terminal;
first and second crimping clasps located on one of the first and second lateral sides of the securing plate and spaced apart from one another;
a first tapered bridge fixedly securing the first crimping clasp to the securing plate; and
a second tapered bridge fixedly securing the second crimping clasp to the securing plate;
wherein:
each of the first and second tapered bridges tapers in width from the securing plate to the respective first and second crimping clasps; and
each of the securing plate, the first and second crimping clasps, and the first and second tapered bridges is made of an electrically conductive material.

11. The electrical system of claim 10, wherein each of the first and second crimping clasps is an O-type crimping clasp.

12. The electrical system of claim 10, wherein the first and second faces of the securing plate lie in corresponding respective first and second planes, and each of the first and second crimping clasps is spaced from both of the first and second planes.

13. The electrical system of claim 12, wherein the first and second crimping clasps have corresponding respective first and second conductor-insertion axes lying in a third plane that is parallel to each of the first and second plane.

14. The electrical system of claim 13, wherein the first and second conductor-insertion axes are parallel to one another.

15. The electrical system of claim 12, wherein each of the first and second tapered bridges extends away from the securing plate at a standoff angle greater than zero degrees relative to each of the first and second planes.

16. The electrical system of claim 15, wherein the standoff angle is between 5 degrees and 30 degrees.

17. The electrical system of claim 10, wherein each of the first and second tapered bridges has first and second lateral sides extending from the securing plate to the corresponding first or second crimping clasp, and each of the first and second lateral sides has a taper angle in a range of 5 degrees to 30 degrees.

18. The electrical system of claim 17, wherein the securing plate has three openings evenly spaced from one another to define first and second inter-opening regions of the securing plate, and each of the first and second tapered bridges is centered relative to a corresponding one of the first and second inter-opening regions.

19. The electrical system of claim 18, wherein the electrical connector is secured to the battery terminal with a plurality of threaded fasteners extending through corresponding respective ones of the plurality of openings.

20. The electrical system of claim 18, wherein the battery module comprises a plurality of lithium cells.
